(19) United States
(12) Patent Application Publication
(10) Pub. No.: US 2013/0018675 A1
(43) Pub. Date: Jan. 17, 2013

(54) Method, System and Program Storage Device for Obtaining Bail Bond Insurance

(71) Applicant: Artour Kagulian, Hollywood, FL (US)

(72) Inventor: Artour Kagulian, Hollywood, FL (US)

(21) Appl. No.: 13/181,212

(22) Filed: Jul. 12, 2011

(51) Int. Cl. G06Q 40/00

(52) U.S. Cl. 705/4

(57) ABSTRACT

A method, system and program storage device in a client/server environment comprises establishing a connection with the server for the purpose of obtaining at least one insurance policy. An individual's request to obtain a bail bond insurance policy is communicated to the server. Personal information is obtained about the individual. The personal information is communicated to the server where the server processes the personal information and generates insurance rate information at least in part based on the personal information. The insurance rate information is received from the server. The insurance rate information is displayed for selection. A selection of the individual is communicated to the server where the server generates a bail bond insurance policy at least in part based on the selection with the individual as the holder of the bail bond insurance policy.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to insurance products. More particularly, the invention relates to personal bail insurance and method of providing same.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following are examples of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that bail laws vary somewhat from state to state. Generally, a person charged with a non-capital crime is granted bail. Some states publish a strict guideline for judges to follow called a bail schedule that lists every crime defined by state law and prescribes a presumptive dollar value of bail for each one. Bail terms include bail bond, cash bond, surety bond, property bond, own recognizance or signature bond, and citation release. However, there are instances where the arrested person cannot come up with the bail term and have to rely on relatives or friends to pay. And if, for some reason or another, the family cannot afford the immediate bail term, then the arrested person is kept in jail until a set trial date. The government pays for each arrested person per day while they are in jail awaiting trial.

Another aspect of the prior art is that traditional insurance contracts called insurance policies are designed to meet specific needs and thus have many features not found in many other types of contracts. These insurance policies detail the conditions and circumstances under which an insured will be financially compensated. Examples of these insurance policies include automobile insurance which covers automobile accidents, homeowner's insurance which covers home related perils, health insurance which covers hospitalization and medicine, etc. However, there is no known personal insurance policy that will provide the immediate payment of a bail amount and allow an arrested person to go free.

Accordingly, an arrested person would generally want a way to help ensure their immediate release so as to avoid the wasted time of staying in jail, and the government would like to save a significant money by having each arrested person to get bailed out faster.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a flowchart 100 depicting an exemplary method of providing bail insurance policy in accordance with an embodiment of the invention.

FIG. 2 is a block diagram depicting an exemplary computing system which may be used as client/server by an exemplary web-enabled and networked embodiment of the present invention.

FIG. 3 shows a flowchart 300 depicting an exemplary web-enabled software program, in accordance with an embodiment of the invention.

Unless otherwise indicated illustrations in the figures are not necessarily drawn to scale.

### SUMMARY OF THE INVENTION

To achieve the forgoing and other objects and in accordance with the purpose of the invention, a variety of methods, systems and program storage devices for obtaining bail bond insurance are described.

In one embodiment a method for obtaining insurance in a client/server environment, the client comprising at least one processor coupled to memory programmed to perform the method comprising the steps of establishing a connection with the server for the purpose of obtaining at least one insurance policy. The method comprises communicating to the server an individual's request to obtain a bail bond insurance policy. The method comprises obtaining personal information about the individual. The method comprises communicating the personal information to the server where the server processes the personal information and generates insurance rate information at least in part based on the personal information. The method comprises receiving from the server the insurance rate information. The method comprises displaying the insurance rate information for selection. The method comprises communicating a selection of the individual to the server where the server generates a bail bond insurance policy at least in part based on the selection with the individual as the holder of the bail bond insurance policy. Another embodiment further comprises the steps of obtaining contact information for the individual, and communicating the contact information to the server. In yet another embodiment the server further stores information for the generated bail bond insurance policy in a customer database with at least password protection. In still another embodiment the personal information at least comprises the individual's age, location and criminal history. In another embodiment the insurance rate information is displayed as a plurality of insurance rates for a plurality of term lengths. Yet another embodiment further comprises the step of communicating to the server an individual's request to obtain an additional insurance policy. Still another embodiment further comprises the steps of establishing a connection with the server for the purpose of obtaining payment on the bail bond insurance policy to post as bail for the individual, communicating at least a password to the server to access the information for the bail bond insurance policy, and communicating circumstances of an arrest of the individual to the server where the server releases the payment.

In another embodiment a system comprises a client programmed to be operable for obtaining and communicating an individual's request to obtain a bail bond insurance policy and personal information about the individual. The client is further operable for displaying insurance rate information for selection and for obtaining and communicating a selection of the individual. The client is further operable for communicating the individual's request to obtain payment on the bail bond insurance policy to post as bail for the individual, at least the password to access the information for the bail bond insurance policy, and circumstances of an arrest of the individual. A server is programmed to be operable for receiving from the client the request to obtain a bail bond insurance policy and personal information about the individual where the server processes the personal information, generates insurance rate information at least in part based on the personal information, and communicates the insurance rate information to the client. The server is further operable for receiving from the client a selection of the individual and for generating a bail bond insurance policy at least in part based on the selection with the individual as the holder of the bail bond insurance policy. The server is further operable for receiving the request to obtain payment on the bail bond insurance policy, the password and the circumstances. The server is further operable for releasing the payment. In another embodiment the client is further operable to obtain contact information for the individual, and communicate the contact information to the server where the server is further operable to receive the contact information. In yet another embodiment the server is further operable to store information for the generated bail bond insurance policy in a customer database with at least password protection. In still another embodiment the personal information at least comprises the individual's age, location and criminal history. In another embodiment the insurance rate information is displayed as a plurality of insurance rates for a plurality of term lengths. In yet another embodiment the client is further operable to communicate an individual's request to obtain an additional insurance policy to the server where the server is further operable to receive the request.

In another embodiment a non-transitory program storage device readable by a machine tangibly embodying a program of instructions executable by the machine to perform a method for obtaining insurance in a client/server environment, comprises computer code for establishing a connection with the server for the purpose of obtaining at least one insurance policy. Computer code communicates to the server an individual's request to obtain a bail bond insurance policy. Computer code obtains personal information about the individual. Computer code for communicates the personal information to the server where the server processes the personal information and generates insurance rate information at least in part based on the personal information. Computer code receives from the server the insurance rate information. Computer code displays the insurance rate information for selection. Computer code communicates a selection of the individual to the server where the server generates a bail bond insurance policy at least in part based on the selection with the individual as the holder of the bail bond insurance policy. Another embodiment further comprises computer code for obtaining contact information for the individual, and communicating the contact information to the server. In yet another embodiment the server further stores information for the generated bail bond insurance policy in a customer database with at least password protection. In still another embodiment the personal information at least comprises the individual's age, location and criminal history. In another embodiment the insurance rate information is displayed as a plurality of insurance rates for a plurality of term lengths. Yet another embodiment further comprises computer code for communicating to the server an individual's request to obtain an additional insurance policy. Still another embodiment further comprises computer code for establishing a connection with the server for the purpose of obtaining payment on the bail bond insurance policy to post as bail for the individual, computer code for communicating at least a password to the server to access the information for the bail bond insurance policy, and computer code for communicating circumstances of an arrest of the individual to the server where the server releases the payment.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

An embodiment of the present invention provides personal bail insurance policy that covers paying for a specified bail amount and ensure the immediate release of an arrested personal bail policy holder.

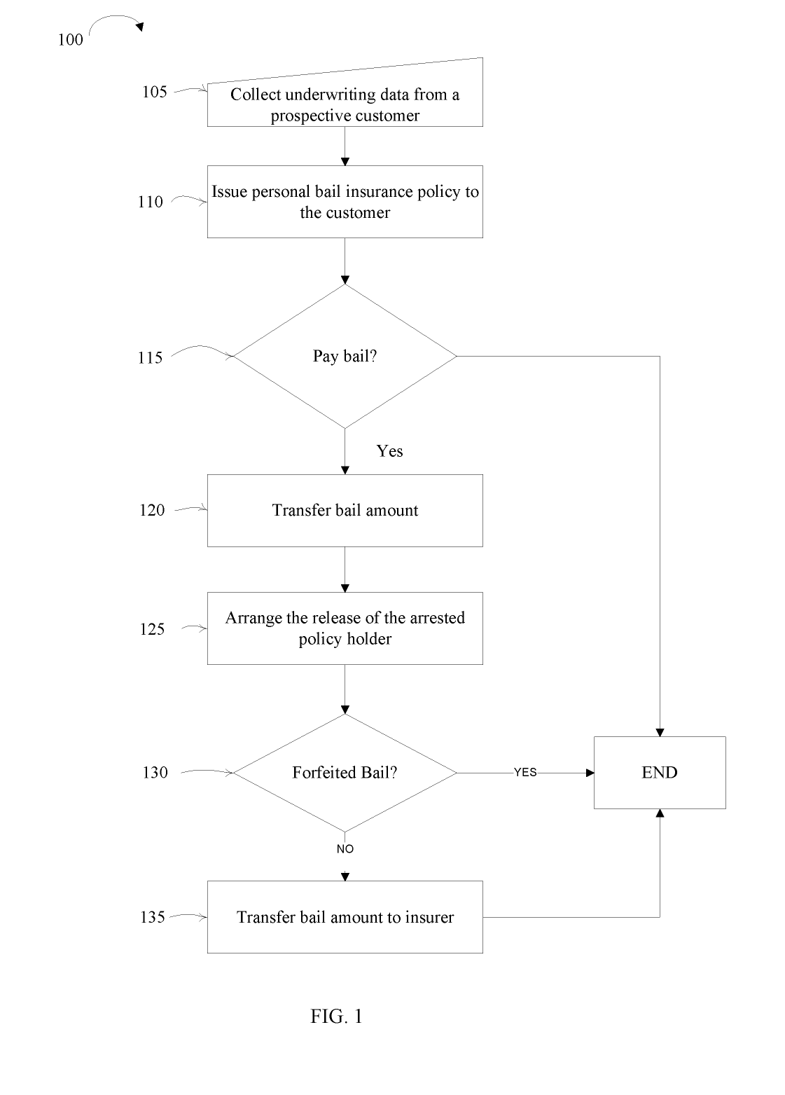

FIG. 1 shows a flowchart 100 depicting an exemplary method of providing bail insurance policy, in accordance with an embodiment of the present invention.

A first step of the present embodiment may begin with a step 105 where an insurer or company selling the personal bail insurance collects underwriting data from a prospective costumer. The process of collecting underwriting data may include creating a bail insurance policy and determining the insurance rate or premium of a customer. The bail insurance policy is a contract between the insurer and the customer detailing the conditions and circumstances under which the customer will be bailed out when arrested. Typically, the customer will provide some form of compensation to the insurer for the insurance policy; by way of example, and not limitation, in exchange for monthly or bi-weekly payments or premium, the insurer would pay for bail amounts which are covered under the bail insurance policy language during the coverage period. Exemplary policy language may include bail as an amount of money that a judge of a court of law sets as a condition for a bail bond policy holder to go free until a set trial date. The bail amount is deposited or pledged to the court by the insurer to persuade the court to release a policy holder from jail with an agreement that the policy holder will return to court at the set trial date. In an alternative embodiment, the process of collecting underwriting data further includes adding additional insurance policy. Additional covered policy includes, but not limited to, court cost and/or fines, lawyer's fees, bail agent's fees, etc.

In a step 110, the customer is issued the personal bail insurance policy and becomes a bail insurance policy holder in accordance with the bail insurance policy.

In a step 115, the bail insurance policy holder is arrested and the Judge sets a bail amount. The bail insurance policy holder contacts the insurer and explains the circumstances of the arrest. The insurer then determines if the circumstances of the arrest are covered under the bail insurance policy.

If covered, the process proceeds to a step 120 where the insurer may transfer the bail amount directly to the court and arrange the release of the policy holder, or , in alternative embodiments, the insurer may transfer the bail amount to an appointed agent of the court, such as, without limitation, a bail agent or bondsman whereby the bail agent would secure the release of the policy holder.

In a step 125, the insurer arranges the release of the policy holder. If the insurer transfers the responsibility to a bail agent to arrange the release of the policy holder, the insurer pays the bail agent's fee. The bail agent then leaves the bail amount with the court in the name of the bail insurance policy holder as a type of guarantee that the policy holder will return for trial.

Typically, the legal process proceeds with the policy holder then appearing in court and the Judge rendering either a guilty or not guilty verdict and closing the case. In a step 130, the court further determines if the bail was forfeited or not. If forfeited, the present method ends with the insurure losing the paid bail amount, otherwise the method proceeds to a Step 135, where the case is closed and the bail was not forfeited, the full bail amount is thereafter returned to the insurer. Typically, if a bail agent arranged for the released of the policy holder, the bail amount minus the bail agent's fee is returned to the insurer, however, a multiplicity of alternative arrangements are possible depending upon the needs of the particular situation.

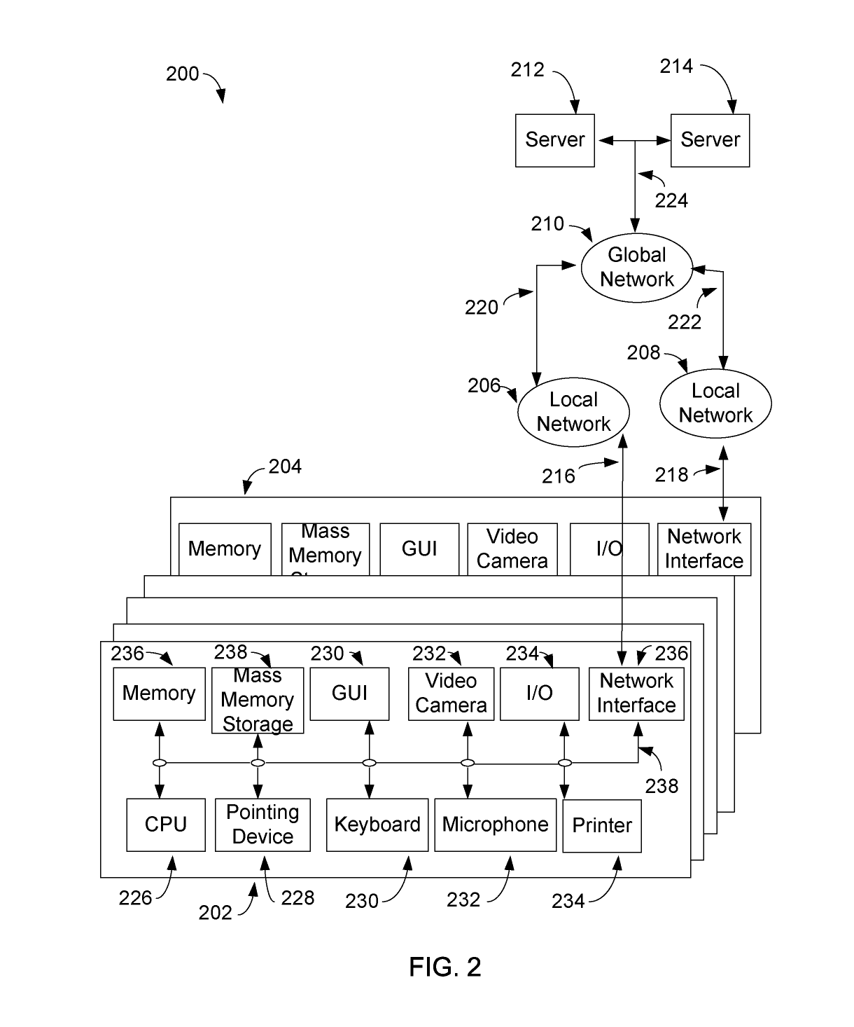

FIG. 2 is a block diagram depicting an exemplary computing system which may be used as client/server by an exemplary web-enabled and networked embodiment of the present invention.

A computing system 200 includes a multiplicity of clients with a sampling of clients denoted as a client 202 and a client 204, a multiplicity of local networks with a sampling of networks denoted as a local network 206 and a local network 208, a global network 210 and a multiplicity of servers with a sampling of servers denoted as a server 212 and a server 214.

Client 202 may communicate bi-directionally with local network 206 via a communication channel 216. Client 204 may communicate bi-directionally with local network 208 via a communication channel 218. Local network 206 may communicate bi-directionally with global network 210 via a communication channel 220. Local network 208 may communicate bi-directionally with global network 210 via a communication channel 222. Global network 210 may communicate bi-directionally with server 212 and server 214 via a communication channel 224. Server 212 and server 214 may communicate bi-directionally with each other via communication channel 224. Furthermore, clients 202, 204, local networks 206, 208, global network 210 and servers 212, 214 may each communicate bi-directionally with each other.

In one embodiment, global network 210 may operate as the Internet. It will be understood by those skilled in the art that communication system 200 may take many different forms. Non-limiting examples of forms for computing system 200 include local area networks (LANs), wide area networks (WANs), wired telephone networks, wireless networks, or any other network supporting data communication between respective entities.

Clients 202 and 204 may take many different forms. Non-limiting examples of clients 202 and 204 include personal computers, personal digital assistants (PDAs), cellular phones and smartphones.

Client 202 includes a CPU 226, a pointing device 228, a keyboard 230, a microphone 232, a printer 234, a memory 236, a mass memory storage 238, a GUI 240, a video camera 242, an input/output interface 244 and a network interface 246.

CPU 226, pointing device 228, keyboard 230, microphone 232, printer 234, memory 236, mass memory storage 238, GUI 240, video camera 242, input/output interface 244 and network interface 246 may communicate in a unidirectional manner or a bi-directional manner with each other via a communication channel 248. Communication channel 248 may be configured as a single communication channel or a multiplicity of communication channels.

CPU 226 may be comprised of a single processor or multiple processors. CPU 226 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 236 is used typically to transfer data and instructions to CPU 226 in a bi-directional manner. Memory 236, as discussed previously, may include any suitable computer-readable media, intended for data storage, such as those described above excluding any wired or wireless transmissions unless specifically noted. Mass memory storage 238 may also be coupled bi-directionally to CPU 226 and provides additional data storage capacity and may include any of the computer-readable media described above. Mass memory storage 238 may be used to store programs, data and the like and is typically a secondary storage medium such as a hard disk. It will be appreciated that the information retained within mass memory storage 238, may, in appropriate cases, be incorporated in standard fashion as part of memory 236 as virtual memory.

CPU 226 may be coupled to GUI 240. GUI 240 enables a user to view the operation of computer operating system and software. CPU 226 may be coupled to pointing device 228. Non-limiting examples of pointing device 228 include computer mouse, trackball and touchpad. Pointing device 228 enables a user with the capability to maneuver a computer cursor about the viewing area of GUI 240 and select areas or features in the viewing area of GUI 240. CPU 226 may be coupled to keyboard 230. Keyboard 230 enables a user with the capability to input alphanumeric textual.

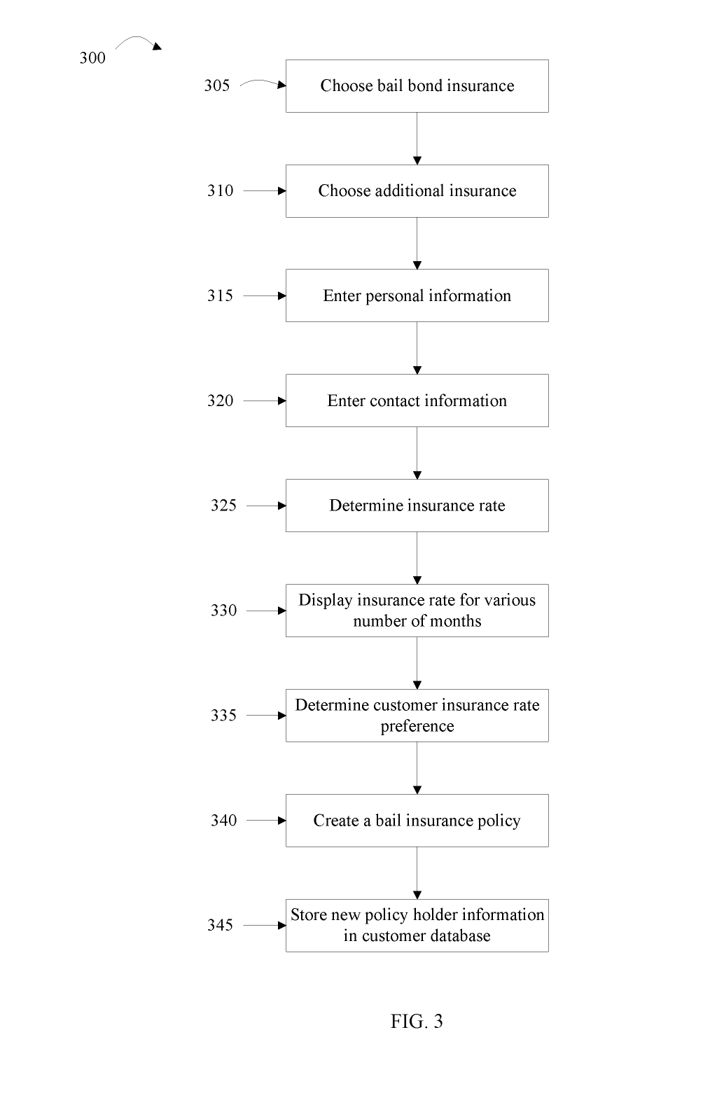

FIG. 3 shows a flowchart 300 depicting an exemplary flowchart of software program, in accordance with an embodiment of the invention.

In a step 305, the prospective customer chooses bail bond insurance from a GUI 230/240 menu.

In a step 310, the prospective customer chooses additional insurance on another GUI 230/240 menu. In an alternative embodiment, this menu may be combined with the menu in step 305

In a step 315, the prospective customer fills in the blank with his/her personal information.

In a step 320, the prospective customer enters his/her contact information. In an alternative embodiment, this menu may be combined with the menu in step 315.

In a step 325, the computing system 200 determines the prospective customer insurance rate based on, but not limited to, the customer's age, location, criminal history, and other risk factors.

In step 330, several insurance rates are displayed for various numbers of months to provide the customer a choice to pick from.

In step 335, the customer chooses and clicks on a preferred insurance rate.

In step 340, the computing system 200 creates a bail insurance policy for the customer.

In step 345, the computing system 200 stores the new policy holder information in a customer database 236/238. In an alternative embodiment, the stored information has been verified to be true and correct. Furthermore, the stored information is secured. The stored information can only be accessed with a correct username and password, Alternatively, the stored information can only be accessed with the correct username, password, and an information related to the policy holder that only the policy holder and insurer would know such as the policy holder's birthday, mother's maiden name, childhood best friend, etc. By way of example, and without limitation, in some applications where stronger security is desired, the stored information when accessed via the network 206/208 or Internet 210, information in a policy holder ID card may be given to the policy holder when the insurance policy is issued needs entered, in addition, to the username, password, and information that only the insurer and policy holder knows.

When the policy holder is arrested, he or she calls the insurer and provide the required security information stated above. After the identity of the caller is verified as one of the policy holder's, then the insurer arranges the release of the policy holder, in accordance with the present embodiment of the invention.

In an alternative embodiment, when the policy holder is arrested, he or she may use the network 206/208 or Internet 210 to verify his or her identity to the insurer by providing the required security information stated above. After the system verifies the policy holder stored information, the system makes an automatic money transfer to the court, equivalent to the prescribed bail amount, to secure the immediate release of the policy holder.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: Collecting underwriting data from prospective customers as shown in the flowchart of FIG. 3.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of providing insurance policy to arrested persons according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for obtaining insurance in a client/server environment, the client comprising at least one processor coupled to memory programmed to perform the method comprising the steps of:
establishing a connection with the server for the purpose of obtaining at least one insurance policy;
communicating to the server an individual's request to obtain a bail bond insurance policy;
obtaining personal information about the individual;
communicating said personal information to the server where the server processes said personal information and generates insurance rate information at least in part based on said personal information;
receiving from the server said insurance rate information;
displaying said insurance rate information for selection; and
communicating a selection of the individual to the server where the server generates a bail bond insurance policy at least in part based on said selection with the individual as the holder of the bail bond insurance policy.

2. The method as recited in claim 1, further comprising the steps of obtaining contact information for the individual, and communicating said contact information to the server.

3. The method as recited in claim 1, in which the server further stores information for said generated bail bond insurance policy in a customer database with at least password protection.

4. The method as recited in claim 1, in which said personal information at least comprises the individual's age, location and criminal history.

5. The method as recited in claim 1, in which said insurance rate information is displayed as a plurality of insurance rates for a plurality of term lengths.

6. The method as recited in claim 1, further comprising the step of communicating to the server an individual's request to obtain an additional insurance policy.

7. The method as recited in claim 1, further comprising the steps of:
establishing a connection with the server for the purpose of obtaining payment on said bail bond insurance policy to post as bail for the individual;
communicating at least a password to the server to access said information for said bail bond insurance policy; and
communicating circumstances of an arrest of the individual to the server where the server releases the payment.

8. A system comprising:
a client programmed to be operable for obtaining and communicating an individual's request to obtain a bail bond insurance policy and personal information about the individual, said client being further operable for displaying insurance rate information for selection and for obtaining and communicating a selection of the individual, said client being further operable for communicating the individual's request to obtain payment on said bail bond insurance policy to post as bail for the individual, at least said password to access said information for said bail bond insurance policy, and circumstances of an arrest of the individual; and
a server programmed to be operable for receiving from said client said request to obtain a bail bond insurance policy and personal information about the individual where the server processes said personal information, generates insurance rate information at least in part based on said personal information, and communicates said insurance rate information to said client, said server being further operable for receiving from said client a selection of the individual and for generating a bail bond insurance policy at least in part based on said selection with the individual as the holder of the bail bond insurance policy, said server being further operable for receiving said request to obtain payment on said bail bond insurance policy, said password and said circumstances, said server being further operable for releasing said payment.

9. The system as recited in claim 8, in which said client is further operable to obtain contact information for the individual, and communicate said contact information to said server where said server is further operable to receive said contact information.

10. The system as recited in claim 8, in which said server is further operable to store information for said generated bail bond insurance policy in a customer database with at least password protection.

11. The system as recited in claim 8, in which said personal information at least comprises the individual's age, location and criminal history.

12. The system as recited in claim 8, in which said insurance rate information is displayed as a plurality of insurance rates for a plurality of term lengths.

13. The system as recited in claim 8, in which said client is further operable to communicate an individual's request to obtain an additional insurance policy to said server where said server is further operable to receive said request.

14. A non-transitory program storage device readable by a machine tangibly embodying a program of instructions executable by the machine to perform a method for obtaining insurance in a client/server environment, comprising:
computer code for establishing a connection with the server for the purpose of obtaining at least one insurance policy;
computer code for communicating to the server an individual's request to obtain a bail bond insurance policy;
computer code for obtaining personal information about the individual;
computer code for communicating said personal information to the server where the server processes said personal information and generates insurance rate information at least in part based on said personal information;
computer code for receiving from the server said insurance rate information;
computer code for displaying said insurance rate information for selection; and
computer code for communicating a selection of the individual to the server where the server generates a bail bond insurance policy at least in part based on said selection with the individual as the holder of the bail bond insurance policy.

15. The non-transitory program storage device as recited in claim 14, further comprising computer code for obtaining contact information for the individual, and communicating said contact information to the server.

16. The non-transitory program storage device as recited in claim 14, in which the server further stores information for said generated bail bond insurance policy in a customer database with at least password protection.

17. The non-transitory program storage device as recited in claim 14, in which said personal information at least comprises the individual's age, location and criminal history.

18. The non-transitory program storage device as recited in claim 14, in which said insurance rate information is displayed as a plurality of insurance rates for a plurality of term lengths.

19. The non-transitory program storage device as recited in claim 14, further comprising computer code for communicating to the server an individual's request to obtain an additional insurance policy.

20. The non-transitory program storage device as recited in claim 14, further comprising:
computer code for establishing a connection with the server for the purpose of obtaining payment on said bail bond insurance policy to post as bail for the individual;
computer code for communicating at least a password to the server to access said information for said bail bond insurance policy; and
computer code for communicating circumstances of an arrest of the individual to the server where the server releases the payment.
